(19) United States
(12) Patent Application Publication
(10) Pub. No.: US 2025/0389652 A1
(43) Pub. Date: Dec. 25, 2025

(54) SURFACE PLASMON MICROSCOPE

(71) Applicant: Hamamatsu Photonics K.K., Hamamatsu-shi (JP)

(72) Inventors: Rumika UCHIDA, Hamamatsu-shi (JP); Koyo Watanabe, Hamamatsu-shi (JP); Kozo Takeuchi, Hamamatsu-shi (JP)

(73) Assignee: Hamamatsu Photonics K.K., Hamamatsu-shi (JP)

(21) Appl. No.: 19/198,316

(22) Filed: May 5, 2025

(30) Foreign Application Priority Data
Jun. 21, 2024 (JP) 2024-100221

(51) Int. Cl. G01N 21/552; G01N 21/41

(52) U.S. Cl. CPC G01N 21/553; G01N 21/41; G01N 2201/0638; G01N 2201/0683

(57) ABSTRACT

An surface plasmon microscope includes a light source, a polarization element, a beam splitter, an objective lens, a photodetector, an operation unit, and the like. An illumination optical system including lenses, the polarization element, the beam splitter, and the objective lens guides light output from the light source to converge the light by the objective lens, and illuminates a metal thin film with the light from a lower surface side of a transparent substrate and focuses the light on the metal thin film to generate a surface plasmon resonance. A detection optical system including the objective lens, the beam splitter, and a lens guides reflected light generated by the focused illumination on the metal thin film to the photodetector. The operation unit acquires refractive index information of a sample disposed in contact with the metal thin film based on the reflected light intensity detected by the photodetector.

### CROSS-REFERENCE TO RELATED APPLICATION

This application is based upon and claims the benefit of priority from Japanese Patent Application No. 2024-100221, filed on Jun. 21, 2024, the entire contents of which are incorporated herein by reference.

### TECHNICAL FIELD

The present disclosure relates to a surface plasmon microscope.

### BACKGROUND

Non Patent Documents 1 and 2 describe a surface plasmon microscope for acquiring refractive index information of a sample by using a surface plasmon resonance (SPR) phenomenon. The surface plasmon microscope described in the above documents is a microscope which acquires the refractive index information of the sample which is disposed in contact with a metal thin film having a thickness of several tens of nm formed on one surface of a transparent substrate. The optical configuration described above is called the Kretschmann configuration.

In the above Kretschmann configuration, in the case in which the metal thin film is illuminated with light from a side of the other surface of the transparent substrate through the transparent substrate, total reflection occurs at an incident angle equal to or larger than a critical angle, and in addition, reflectance rapidly decreases at a certain specific incident angle equal to or larger than the critical angle. A phenomenon in which the reflectance rapidly decreases as described above is caused by the fact that, when a wavenumber of a surface plasmon, which is an oscillation of free electron gas localized on the surface of the metal thin film, and a wavenumber of an evanescent wave of the incident light coincide with each other, a resonance phenomenon between the two occurs, and the energy of the light moves to the metal surface. The above phenomenon is called the surface plasmon resonance phenomenon. The incident angle of the light at which the surface plasmon resonance occurs is referred to as a plasmon resonance angle (or simply a resonance angle).

The resonance angle depends on a refractive index of a portion at which the evanescent wave of the incident light arrives in the sample which is disposed in contact with the metal thin film formed on the one surface of the transparent substrate. Therefore, when the incident angle (the resonance angle) at which the reflectance is minimized in a range of the critical angle or more is measured, the refractive index information of the sample can be acquired from the above resonance angle. Further, a distribution of the refractive index information of the sample can be acquired by scanning a position of the light incidence on the metal thin film. For example, there have been reports of examples used for a surface of a cell, bioassay, and detection of a micro particle such as an exosome.

The surface plasmon microscope described in Non Patent Document 1 focuses the light converged by an objective lens on the metal thin film, and images a reflected light intensity distribution on an exit pupil plane of the objective lens at that time by using an imaging sensor. Further, the surface plasmon microscope obtains the resonance angle based on a radius of an absorption ring appearing in the reflected light intensity distribution, and acquires the refractive index information of the sample from the resonance angle.

The surface plasmon microscope described in Non Patent Document 2 illuminates an entrance pupil plane of the objective lens with the light having a ring shape with a radius corresponding to an incident angle close to the resonance angle, illuminates the metal thin film with the light having the ring shape on the entrance pupil plane at a certain incident angle by the objective lens, and measures the intensity of the reflected light at that time. Further, the surface plasmon microscope obtains the resonance angle based on the reflected light intensity, and acquires the refractive index information of the sample from the resonance angle.
Non Patent Document 1: K. Watanabe et al., “High resolution imaging of patterned model biological membranes by localized surface plasmon microscopy”, APPLIED OPTICS, Vol. 49, No. 5, pp. 887-891, 2010
Non Patent Document 2: K. Watanabe et al., “Localized surface plasmon microscope with an illumination system employing a radially polarized zeroth-order Bessel beam”, OPTICS LETTERS, Vol. 34, No. 8, pp. 1180-1182, 2009
Non Patent Document 3: Hiroshi KANO and Kouyou WATANABE, “Scanning Localized Surface Plasmon Microscope with Radially Polarized Illumination”, Japanese Journal of Optics (KOGAKU), Vol. 35, No. 12, pp. 652-654, 2006

### SUMMARY

The surface plasmon microscope described in Non Patent Document 1 is preferable in that the refractive index information of the sample can be accurately obtained by using a relatively simple optical system. However, the above surface plasmon microscope images the reflected light intensity distribution on the exit pupil plane of the objective lens with the imaging sensor, and thus, a measurement time is long, and further, an analysis for obtaining the radius of the absorption ring based on the reflected light intensity distribution is required.

The surface plasmon microscope described in Non Patent Document 2 is preferable in that the measurement time is short because the reflected light intensity may be measured by using a point sensor. However, the above surface plasmon microscope requires a complicated optical system for illuminating the entrance pupil plane of the objective lens with the light having the ring shape.

An object of an embodiment is to provide a surface plasmon microscope capable of achieving simplification of a configuration and an analysis and reduction of a measurement time.

An embodiment is a surface plasmon microscope. The surface plasmon microscope is a surface plasmon microscope for acquiring refractive index information of a sample disposed in contact with a metal thin film by using a surface plasmon resonance phenomenon, and includes (1) a light source for outputting light; (2) an illumination optical system for focusing the light output from the light source on the metal thin film through an objective lens to generate a surface plasmon resonance; (3) a detection optical system for guiding reflected light generated by focused illumination on the metal thin film by the illumination optical system through the objective lens; (4) a photodetector for receiving the reflected light arriving through the detection optical system, and detecting an intensity of the reflected light; and (5) an operation unit for acquiring the refractive index information of the sample based on the intensity of the reflected light detected by the photodetector.

According to the surface plasmon microscope of the embodiment, it is possible to achieve simplification of a configuration and an analysis and reduction of a measurement time in the surface plasmon microscope.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIG. 1 is a diagram illustrating a configuration of a surface plasmon microscope 1A.

FIG. 2 is a diagram illustrating a configuration around an objective lens 27 in the surface plasmon microscope 1A.

FIG. 3 is a diagram illustrating a configuration of a surface plasmon microscope 1B.

FIG. 4 is a diagram illustrating a configuration of a surface plasmon microscope 1C.

FIG. 5A to FIG. 5C are diagrams each schematically showing an intensity distribution of reflected light on a pupil plane of the objective lens 27.

FIG. 6 is a diagram schematically showing the intensity distribution of the reflected light on the pupil plane of the objective lens 27.

FIG. 7 is a graph showing a relationship between a light incident angle on a metal thin film 73 and a reflectance in the case in which the metal thin film 73 is set to a gold thin film.

FIG. 8 is a graph showing a relationship between the light incident angle on the metal thin film 73 and the reflectance in the case in which the metal thin film 73 is set to a silver thin film.

FIG. 9A to FIG. 9C are diagrams each showing the reflected light intensity distribution on the pupil plane of the objective lens 27 in the case in which the metal thin film 73 is set to the silver thin film.

FIG. 10 is a graph showing a relative change of the reflected light intensity on the pupil plane of the objective lens 27 in the case in which the metal thin film 73 is set to the silver thin film and a refractive index of a sample 74 is changed.

FIG. 11A and FIG. 11B are diagrams each showing the reflected light intensity distribution on the pupil plane of the objective lens 27 in the case in which a thickness of the metal thin film 73 is set to 30 nm.

FIG. 12A and FIG. 12B are diagrams each showing the reflected light intensity distribution on the pupil plane of the objective lens 27 in the case in which the thickness of the metal thin film 73 is set to 54 nm.

FIG. 13 is a graph showing a relative change of the reflected light intensity on the pupil plane of the objective lens 27 in the case in which the metal thin film 73 is set to the silver thin film and the refractive index of the sample 74 is changed.

FIG. 14A and FIG. 14B are diagrams each showing the reflected light intensity distribution on the pupil plane of the objective lens 27 in the case in which a low frequency cut filter is provided or in the case in which the low frequency cut filter is not provided.

FIG. 15 is a graph showing a change of a sensitivity in the case in which the metal thin film 73 is set to the silver thin film with a thickness of 30 nm and a diameter of the low frequency cut filter is changed.

FIG. 16 is a graph showing a relative change of the reflected light intensity on the pupil plane of the objective lens 27 in the case in which the metal thin film 73 is set to the silver thin film with the thickness of 30 nm and the refractive index of the sample 74 is changed.

FIG. 17A to FIG. 17C are diagrams each showing the reflected light intensity distribution on the pupil plane of the objective lens 27 in the case in which the low frequency cut filter is not provided or in the case in which the low frequency cut filter is provided.

FIG. 18 is a diagram illustrating a configuration of a surface plasmon microscope 1D.

FIG. 19 is a diagram illustrating a configuration of a surface plasmon microscope 1E.

### DETAILED DESCRIPTION

Hereinafter, embodiments of a surface plasmon microscope will be described in detail with reference to the accompanying drawings. In the description of the drawings, the same elements will be denoted by the same reference signs, and redundant description will be omitted. The present invention is not limited to these examples, and the Claims, their equivalents, and all the changes within the scope are intended as would fall within the scope of the present invention.

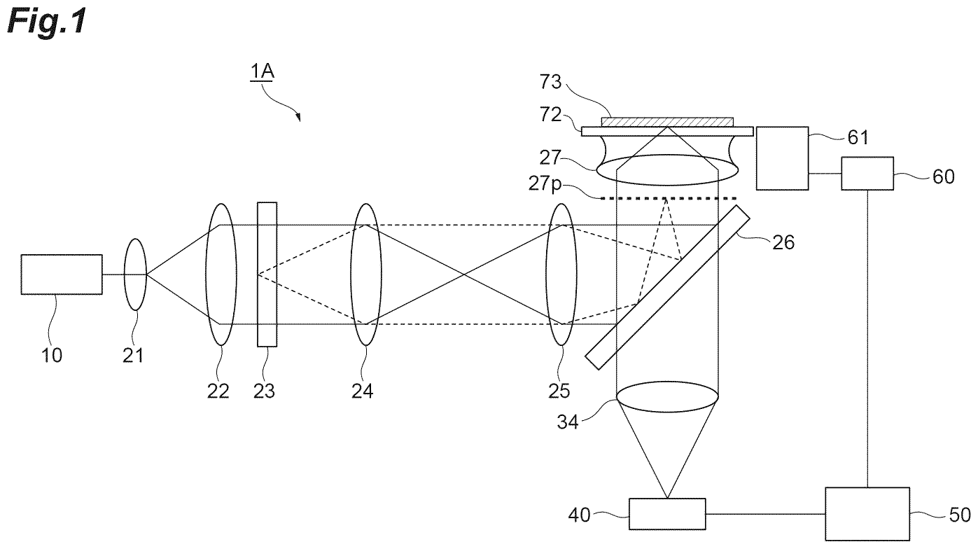

FIG. 1 is a diagram illustrating a configuration of a surface plasmon microscope 1A. The surface plasmon microscope 1A is a microscope for acquiring refractive index information of a sample disposed in contact with a metal thin film 73 which is formed on one surface (an upper surface) of a transparent substrate 72 by using a surface plasmon resonance phenomenon.

The surface plasmon microscope 1A includes a light source 10, a lens 21, a lens 22, a polarization element 23, a lens 24, a lens 25, a beam splitter 26, an objective lens 27, a lens 34, a photodetector 40, an operation unit 50, a stage drive unit 60, and a stage 61.

The light source 10 is a light source for outputting light to be focused on the metal thin film 73 and with which the metal thin film 73 is illuminated, and is preferably a laser light source. The lens 21, the lens 22, the polarization element 23, the lens 24, the lens 25, the beam splitter 26, and the objective lens 27 constitute an illumination optical system. The illumination optical system guides the light output from the light source 10 to converge the light by the objective lens 27, and illuminates the metal thin film 73 with the light from a side of the other surface (a lower surface) of the transparent substrate 72 and focuses the light on the metal thin film 73 to generate a surface plasmon resonance.

The lenses 21 and 22 constitute a beam expander for expanding a beam diameter of the light output from the light source 10 and collimating the light. That is, the lens 21 inputs the light output from the light source 10 and converges the light once, and further, the lens 22 inputs the light after the convergence and collimates the light to output the light to the polarization element 23.

The polarization element 23 inputs the light which is collimated and output from the lens 22, converts the light to be focused to illuminate the metal thin film 73 from linear polarization into radial polarization, and outputs the light to the lens 24. The polarization element 23 may include, for example, a z polarization element, an axially symmetric polarization conversion element, or the like. The polarization element 23 may have a configuration in which a π step phase plate and a liquid crystal cell are combined (see Non Patent Document 3).

The lenses 24 and 25 are provided between the polarization element 23 and an entrance pupil plane 27p of the objective lens 27, and constitute a 4f optical system, and further, relay a light intensity distribution on the polarization element 23 onto the entrance pupil plane 27p. In the illumination optical system, the beam splitter 26 is provided on an optical path between the lens 25 and the objective lens 27, and reflects the light arriving from the lens 25 to the objective lens 27.

The objective lens 27 inputs the light arriving from the beam splitter 26 and converges the light, illuminates the metal thin film 73 with the light from the side of the lower surface of the transparent substrate 72, and focuses the light on the metal thin film 73 which is formed on the upper surface of the transparent substrate 72. The surface plasmon resonance is generated by the above focused illumination. A configuration around the objective lens 27 will be described later.

The objective lens 27, the beam splitter 26 and the lens 34 constitute a detection optical system. The detection optical system guides reflected light which is generated by the focused illumination of the light on the metal thin film 73 by the illumination optical system to the photodetector 40 through the objective lens 27, the beam splitter 26, and the lens 34. In the detection optical system, the beam splitter 26 is provided on an optical path between the objective lens 27 and the lens 34, and transmits the reflected light arriving from the objective lens 27 to the lens 34.

In addition, in the illumination optical system, the polarization element 23 may not be provided, and further, it is preferable that the polarization element 23 is provided in order to improve a measurement sensitivity of a refractive index. In the illumination optical system, the lenses 24 and 25 constituting the 4f optical system may not be provided. Further, the detection optical system may include a 4f optical system.

The photodetector 40 receives the reflected light arriving through the detection optical system, and detects an intensity of the reflected light. The photodetector 40 may be a point sensor, and for example, may be a photodiode, a photomultiplier tube, or the like. The reflected light intensity which is detected as described above reflects reflectance reduction due to the surface plasmon resonance, and depends on a radius of an absorption ring appearing in a reflected light intensity distribution on an exit pupil plane of the objective lens 27, and further, depends on a refractive index of a portion at which an evanescent wave of the incident light arrives in the sample which is placed on the metal thin film 73.

The operation unit 50 acquires the refractive index information of the sample disposed in contact with the metal thin film 73 based on the intensity of the reflected light detected by the photodetector 40. The refractive index information which is acquired in this case is information on the refractive index of the portion at which the evanescent wave of the incident light arrives in the sample which is placed on the metal thin film 73. The refractive index information may be the refractive index itself, or may be a difference or a ratio of the refractive index with a predetermined reference value.

The operation unit 50 may be physically configured by using a computer including a memory such as a RAM, a ROM, and the like, a processor (an operation circuit) such as a CPU and the like, a communication interface, a storage unit such as an SSD, a hard disk, and the like, and a display unit such as a display and the like. The operation unit 50 functions by executing a program which is stored in the memory by using the CPU. The operation unit 50 may be configured by using a microcomputer, a programmable logic controller (PLC), a field-programmable gate array (FPGA), or the like.

The stage drive unit 60 and the stage 61 constitute a scanning unit for scanning a position of the focused illumination of the light on the metal thin film 73 by the illumination optical system. That is, the stage drive unit 60 drives the stage 61 supporting the transparent substrate 72 to move the transparent substrate 72 in a direction perpendicular to an optical axis of the objective lens 27. The stage 61 may be configured by using a piezo stage or an electrically driven stage. The operation unit 50 can acquire the information on the refractive index distribution of the sample based on the information on the position of the focused illumination of the light on the metal thin film 73 by the illumination optical system, and the intensity of the reflected light detected by the photodetector 40.

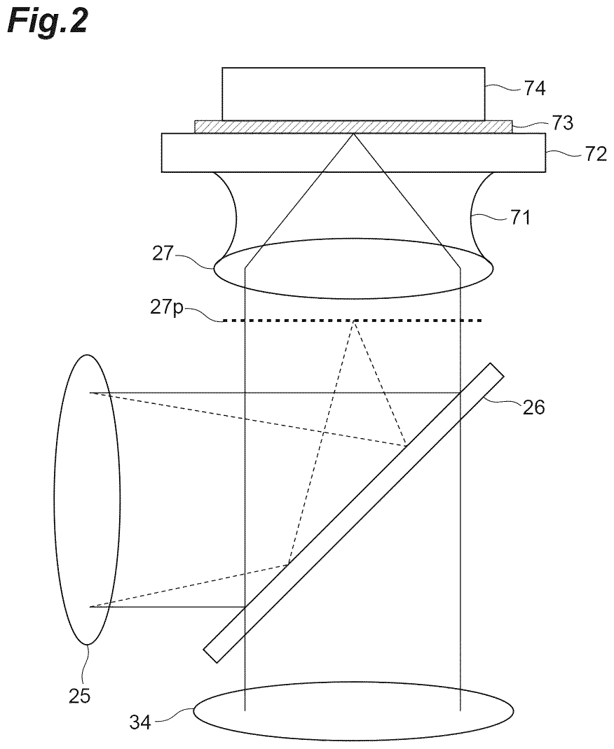

FIG. 2 is a diagram illustrating a configuration around the objective lens 27 in the surface plasmon microscope 1A. The metal thin film 73 is formed on the upper surface of the transparent substrate 72, and a sample 74 is disposed in contact with the metal thin film 73. The transparent substrate 72 is, for example, a glass flat plate. The metal thin film 73 is, for example, a gold thin film or a silver thin film, and has a thickness of several tens of nm. An immersion oil 71 is filled between the lower surface of the transparent substrate 72 and the objective lens 27. It is preferable that the refractive index of the immersion oil 71 and the refractive index of the transparent substrate 72 are equal to each other.

In the above configuration, the light which is input from the lens 25 to the beam splitter 26 and reflected by the beam splitter 26 is converged by the objective lens 27, and the light is focused on the metal thin film 73 through the immersion oil 71 and the transparent substrate 72. The surface plasmon resonance is generated by the above focused illumination of the light. The reflected light generated by the focused illumination on the metal thin film 73 is transmitted through the beam splitter 26 through the transparent substrate 72, the immersion oil 71, and the objective lens 27, and the reflected light is received by the photodetector 40 through the lens 34.

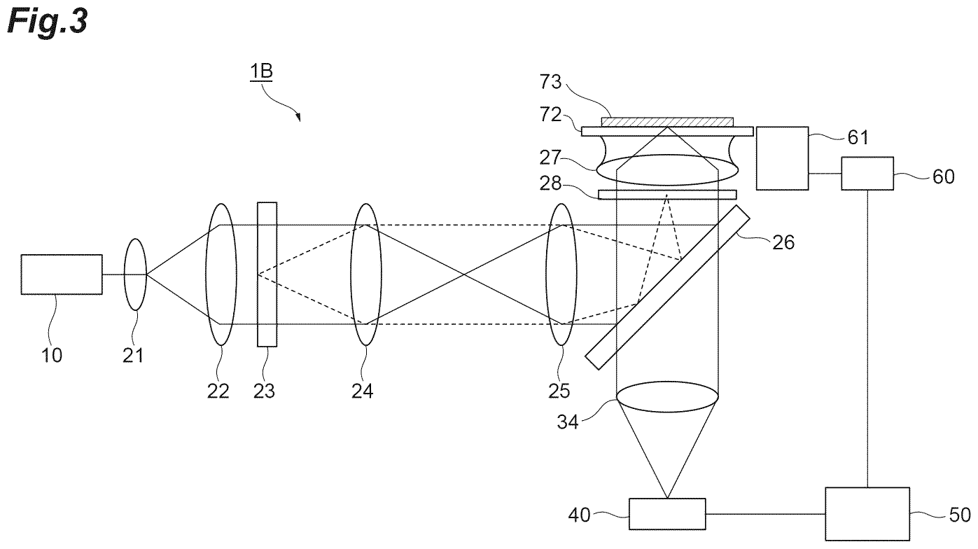

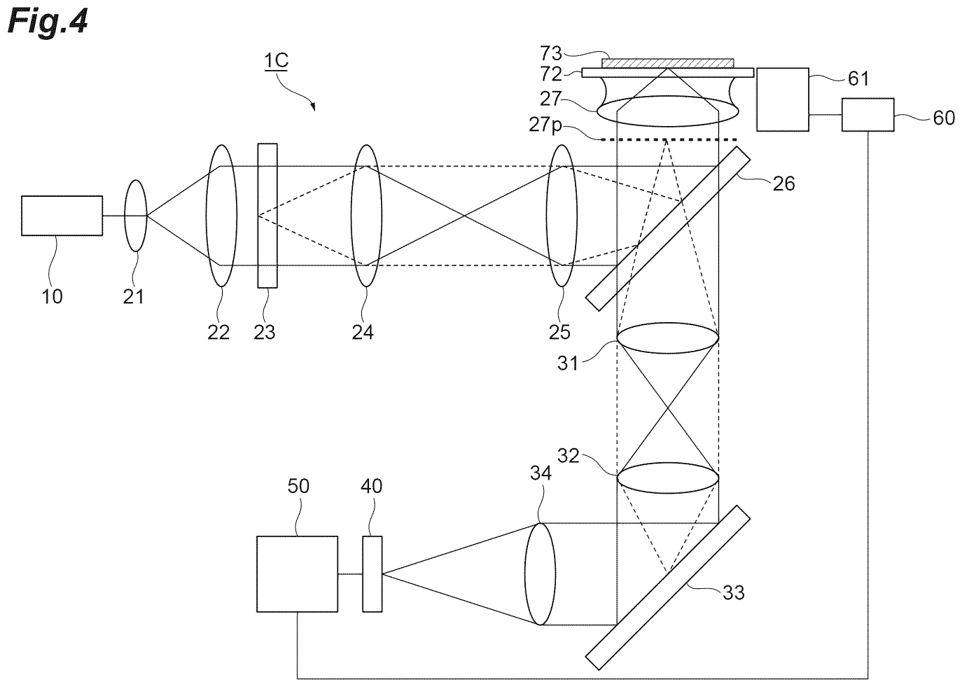

Next, as a modification of the configuration of the surface plasmon microscope 1A (FIG. 1), a configuration in which a low frequency cut filter is provided will be described with reference to FIG. 3 and FIG. 4. The low frequency cut filter is provided on an optical path of the illumination optical system or the detection optical system, and reduces a low frequency component inside the absorption ring out of the reflected light which is to be received by the photodetector 40. The low frequency cut filter may reduce the intensity of the light in a partial region out of the region of the absorption ring.

It is preferable that the low frequency cut filter is provided in an optical path portion in which the light is collimated and propagated. It is preferable that the low frequency cut filter is provided, for example, at a position near the polarization element 23 in the illumination optical system, a position between the lens 25 and the pupil plane of the objective lens 27 in the illumination optical system, or a position between the pupil plane of the objective lens 27 and the lens 34 in the detection optical system.

The reduction of the intensity of the light in the low frequency region by the low frequency cut filter may be total blocking of the light (a blocking ratio=100%), or may be partial blocking of the light (a blocking ratio <100%). The low frequency cut filter may be a cut filter which is configured by using a spatial light modulator in which a spatial transmittance distribution is set by an electrical signal provided from the outside, and further, it is preferable that, in terms of size reduction, the low frequency cut filter is configured by using a mask of a transmission type in which a blocking region including a center position and a surrounding transmission region are physically formed.

FIG. 3 is a diagram illustrating a configuration of a surface plasmon microscope 1B. As compared with the configuration of the surface plasmon microscope 1A (FIG. 1), the surface plasmon microscope 1B (FIG. 3) is different in that the microscope further includes a low frequency cut filter 28.

In this diagram, the low frequency cut filter 28 is provided at a position of the pupil plane of the objective lens 27. In both the illumination optical system and the detection optical system, the low frequency cut filter 28 reduces the intensity of the low frequency component (the light corresponding to the low frequency region including the center position of the light intensity distribution on the pupil plane of the objective lens 27) inside the absorption ring out of the reflected light to be received by the photodetector 40.

FIG. 4 is a diagram illustrating a configuration of a surface plasmon microscope 1C. As compared with the configuration of the surface plasmon microscope 1A (FIG. 1), the surface plasmon microscope 1C (FIG. 4) is different in that the microscope further includes a lens 31, a lens 32, and a low frequency cut filter 33 between the beam splitter 26 and the lens 34 on the optical path of the detection optical system.

The low frequency cut filter 33 is a cut filter having a function similar to that of the low frequency cut filter 28, and further, in this case, the low frequency cut filter 33 is configured by using a spatial light modulator of a reflection type in which a spatial modulation distribution is set by an electrical signal provided from the outside. The lens 31 and the lens 32 project the pupil plane 27p of the objective lens 27 onto the low frequency cut filter 33. In this configuration example, the region in which the light intensity is reduced by the low frequency cut filter 33 and the degree of reduction can be easily adjusted.

Next, the light intensity which is detected by the photodetector 40 in each of the case in which the low frequency cut filter is not provided and the case in which the low frequency cut filter is provided is represented by a mathematical formula. In the case in which an effective refractive index of the sample 74 in the vicinity of the metal thin film 73 changes from n₁ to n₂, an SPR reflectance curve in the case in which the effective refractive index is n₁ is set to SPR₁(ρ, n₁), an SPR reflectance curve in the case in which the effective refractive index is n₂ is set to SPR₂(ρ, n₂), and a change amount ΔI of the reflected light intensity can be represented by using the above SPR reflectance curves.

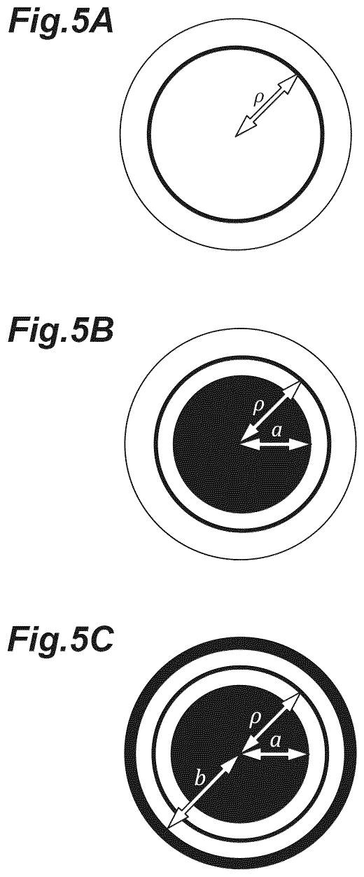

In the case in which the intensity distribution of the reflected light on the pupil plane of the objective lens 27 is set to a distribution shown in FIG. 5A, ΔI is represented as in the following Formula (1), in the case in which the intensity distribution is set to a distribution shown in FIG. 5B, ΔI is represented as in the following Formula (2), and in the case in which the intensity distribution is set to a distribution shown in FIG. 5C, ΔI is represented as in the following Formula (3). In these formulas, ρ and α are variables indicating a radial distance from the center position on the pupil plane and an azimuthal angle. A magnitude relationship of the refractive index is set to n₁<n₂.

$$\begin{matrix}[ Formula 1 ] & \\ Δ I = {\int }_{α} {\int }_{ρ} {SPR}_{1} ( ρ , {n}_{1} ) d ρ d α - {\int }_{α} {\int }_{ρ} {SPR}_{2} ( ρ , {n}_{2} ) d ρ d α & ( 1 )\end{matrix}$$

$$\begin{matrix}[ Formula 2 ] & \\ Δ I = ( {\int }_{α} {\int }_{ρ} {SPR}_{1} ( ρ , {n}_{1} ) d ρ d α - {\int }_{α} {\int }_{0}^{a} {SPR}_{1} ( ρ , {n}_{1} ) d ρ d α ) - ( {\int }_{α} {\int }_{ρ} {SPR}_{2} ( ρ , {n}_{2} ) d ρ d α - {\int }_{α} {\int }_{0}^{a} {SPR}_{2} ( ρ , {n}_{2} ) d ρ d α ) & ( 2 )\end{matrix}$$

$$\begin{matrix}[ Formula 3 ] & \\ Δ I = ( {\int }_{α} {\int }_{ρ} {SPR}_{1} ( ρ , {n}_{1} ) d ρ d α - {\int }_{α} {\int }_{0}^{α} {SPR}_{1} ( ρ , {n}_{1} ) d ρ d α - {\int }_{α} {\int }_{b}^{∞} {SPR}_{1} ( ρ , {n}_{1} ) d ρ d α ) - ( {\int }_{a} {\int }_{ρ} {SPR}_{2} ( ρ , {n}_{2} ) d ρ d α - {\int }_{α} {\int }_{0}^{α} {SPR}_{2} ( ρ , {n}_{2} ) d ρ d α - {\int }_{α} {\int }_{b}^{∞} {SPR}_{2} ( ρ , {n}_{2} ) d ρ d α ) & ( 3 )\end{matrix}$$

FIG. 5A to FIG. 5C are diagrams each schematically showing the intensity distribution of the reflected light on the pupil plane of the objective lens 27. In these diagrams, a black region indicates the region of the absorption ring (with the radius of p) and the blocking region with the blocking ratio of 100%.

FIG. 5A is a diagram schematically showing the intensity distribution of the reflected light on the pupil plane in the case in which the low frequency cut filter and a high frequency cut filter are not provided. FIG. 5B is a diagram schematically showing the intensity distribution of the reflected light after passing through the low frequency cut filter in the case in which the low frequency cut filter is provided on the position of the pupil plane of the objective lens 27. FIG. 5C is a diagram schematically showing the intensity distribution of the reflected light after passing through the filter in the case in which the filter for cutting both the low frequency component and the high frequency component is provided on the position of the pupil plane of the objective lens 27.

A radius a of the light blocking region of the low frequency cut filter shown in FIG. 5B and FIG. 5C is set to be smaller than the radius p of the absorption ring. An inner radius b of the light blocking region of the high frequency cut filter shown in FIG. 5C is set to be larger than the radius p of the absorption ring.

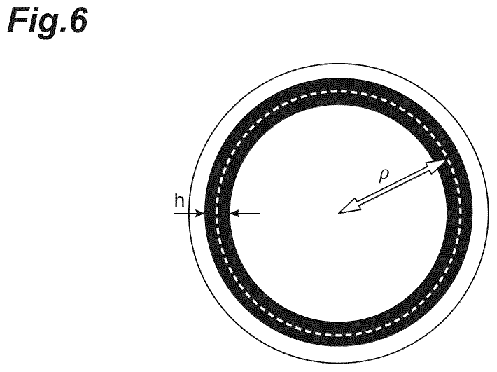

In particular, in the case shown in FIG. 5A, when the radius of the absorption ring in the case in which the effective refractive index of the sample 74 in the vicinity of the metal thin film 73 is n₁ and n₂ is set to ρ₁ and ρ₂, respectively, a radial width of the region of the absorption ring is set to h (FIG. 6), and a difference between n₁ and n₂ is set to be sufficiently small, the above Formula (1) can be approximated by the following Formula (4). In addition, when a relational formula (see Non Patent Document 1) between the radius ρ of the absorption ring, an angular frequency ω, the speed of light c in vacuum, and a complex refractive index nₘ of the metal thin film is used, the following Formula (4) is represented by the following Formula (5).

$$\begin{matrix}[ Formula 4 ] & \\ \begin{matrix}Δ I \approx \{ {π ( {ρ}_{1} + \frac{1}{2} h )}^{2} - {π ( {ρ}_{1} - \frac{1}{2} h )}^{2} \} - \{ π {( {ρ}_{2} + \frac{1}{2} h )}^{2} - {π ( {ρ}_{2} - \frac{1}{2} h )}^{2} \} \\ = 2 π h ( {ρ}_{1} - {ρ}_{2} )\end{matrix} & ( 4 )\end{matrix}$$

$$\begin{matrix}[ Formula 5 ] & \\ Δ I \approx 2 π h ( Real ( \frac{ω}{c} {( \frac{{n}_{m}^{2} {n}_{1}^{2}}{{n}_{m}^{2} + {n}_{1}^{2}} )}^{1 / 2} ) - Real ( \frac{ω}{c} {( \frac{{n}_{m}^{2} {n}_{2}^{2}}{{n}_{m}^{2} + {n}_{2}^{2}} )}^{1 / 2} ) ) & ( 5 )\end{matrix}$$

As can be seen from the above formula, the wider the radial width h of the region of the absorption ring, the larger the ΔI and the higher the sensitivity. In addition, the above point is opposite to the technique of Non Patent Document 2 in which the narrower the radial width h of the region of the absorption ring, the higher the sensitivity.

Next, simulation results will be described. In the present simulation, it is assumed that each of the objective lens 27 and the transparent substrate 72 is made of glass having a refractive index of 1.78, and the refractive index of the immersion oil 71 is also 1.78.

A gold thin film or a silver thin film which is deposited on the surface of the transparent substrate 72 is assumed as the metal thin film 73. The complex refractive index of gold is 0.54386+2.2309i, and the complex refractive index of silver is 0.054007+3.4290i. Water is assumed as the sample 74. The refractive index of water is 1.3337. A wavelength of the light output from the light source 10 is set to 532 nm, which is a corresponding wavelength of a commercially available polarization element. Under the above conditions, the thickness of the metal thin film 73 is variously set, and the SPR reflectance curve is calculated.

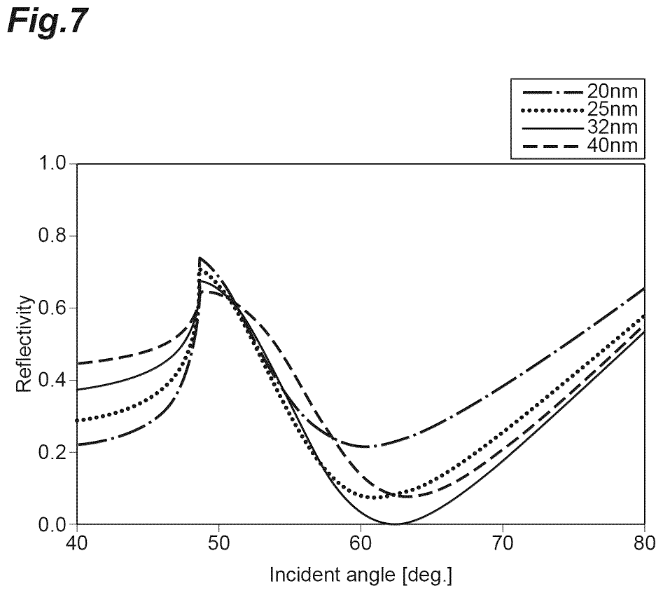

FIG. 7 is a graph showing a relationship between the light incident angle on the metal thin film 73 and the reflectance in the case in which the metal thin film 73 is set to the gold thin film. In this graph of FIG. 7, the SPR reflectance curves in the cases in which the thickness of the metal thin film 73 is set to respective values of 20 nm, 25 nm, 32 nm, and 40 nm are shown.

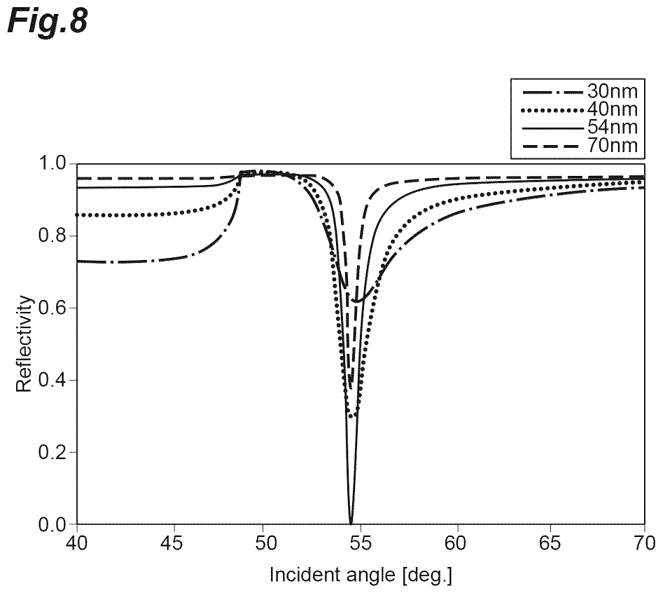

FIG. 8 is a graph showing a relationship between the light incident angle on the metal thin film 73 and the reflectance in the case in which the metal thin film 73 is set to the silver thin film. In this graph of FIG. 8, the SPR reflectance curves in the cases in which the thickness of the metal thin film 73 is set to respective values of 30 nm, 40 nm, 54 nm, and 70 nm are shown.

When FIG. 7 and FIG. 8 are compared, the following can be said. Gold has absorption in a visible region, and thus, the absorption peak is broader than that in the case of silver. In consideration of the above, in the technique described in Non Patent Documents 1 and 2, it can be said that it is preferable to use the silver thin film rather than the gold thin film as the metal thin film in terms of the sensitivity or the accuracy. However, as will be described later, in the present embodiment, it may be preferable to use the gold thin film rather than the silver thin film as the metal thin film in some cases at a certain point of view.

Further, when the silver thin film is used as the metal thin film, the absorption peak becomes sharper and the reflectance becomes lower as the thickness is increased from 30 nm to 54 nm out of the thicknesses of the four cases. However, when the thickness is further set to 70 nm, the reflectance increases although the absorption peak is sharp. In consideration of the above, in the technique described in Non Patent Documents 1 and 2, it can be said that, when the silver thin film is used as the metal thin film, the thickness of 54 nm is preferable out of the thicknesses of the four cases.

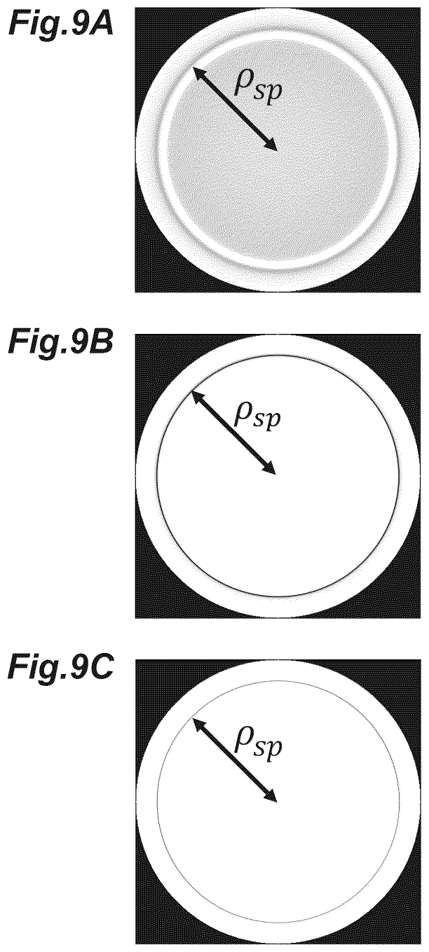

FIG. 9A to FIG. 9C are diagrams each showing the reflected light intensity distribution on the pupil plane of the objective lens 27 in the case in which the metal thin film 73 is set to the silver thin film. FIG. 9A is a diagram showing the reflected light intensity distribution in the case in which the thickness of the metal thin film is set to 30 nm. FIG. 9B is a diagram showing the reflected light intensity distribution in the case in which the thickness of the metal thin film is set to 54 nm. FIG. 9C is a diagram showing the reflected light intensity distribution in the case in which the thickness of the metal thin film is set to 70 nm. As can be seen by comparing FIG. 9A to FIG. 9C, in the case in which the thickness of the metal thin film is set to 54 nm, the absorption peak is the sharpest, and the absorption ring is the clearest. The above result is consistent with the result shown in FIG. 8.

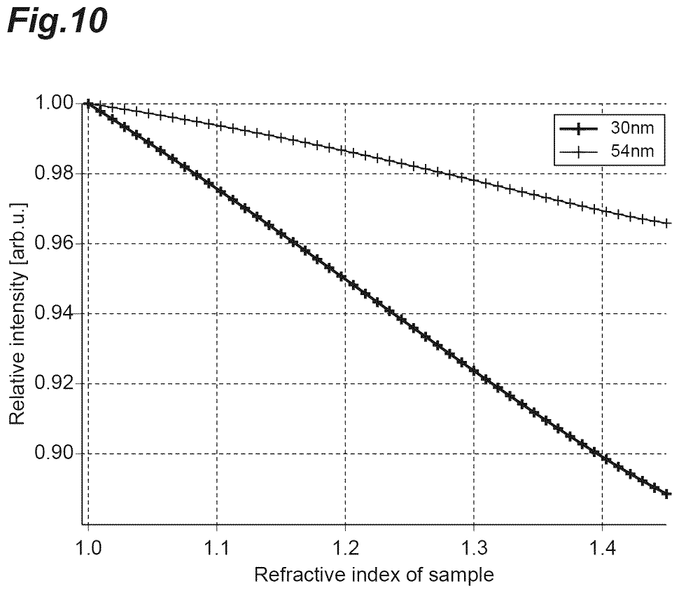

FIG. 10 is a graph showing a relative change of the reflected light intensity on the pupil plane of the objective lens 27 in the case in which the metal thin film 73 is set to the silver thin film and the refractive index of the sample 74 is changed. In this graph of FIG. 10, the relative changes of the reflected light intensity in the cases in which the thickness of the metal thin film 73 is set to respective values of 30 nm and 54 nm and when the refractive index of the sample 74 is changed from 1.0 to 1.45 are shown. The reflected light intensity in the case in which the refractive index of the sample 74 is set to 1.0 is used as the reference value.

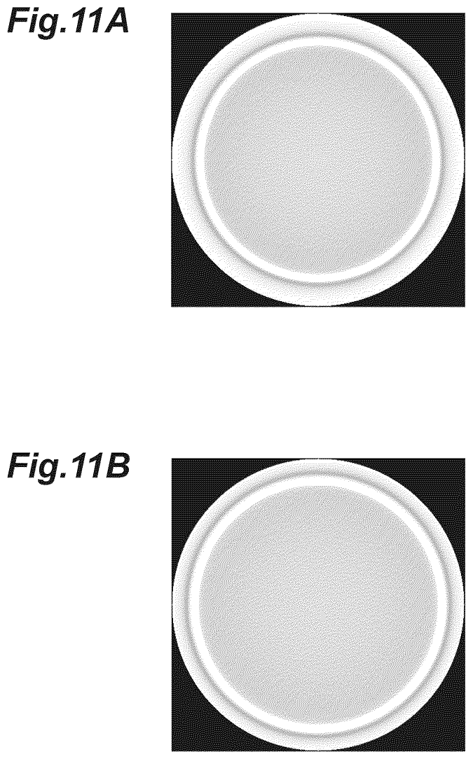

FIG. 11A is a diagram showing the reflected light intensity distribution on the pupil plane of the objective lens 27 in the case in which the thickness of the metal thin film 73 is set to 30 nm and the refractive index of the sample is set to 1.33. FIG. 11B is a diagram showing the reflected light intensity distribution on the pupil plane of the objective lens 27 in the case in which the thickness of the metal thin film 73 is set to 30 nm and the refractive index of the sample is set to 1.40.

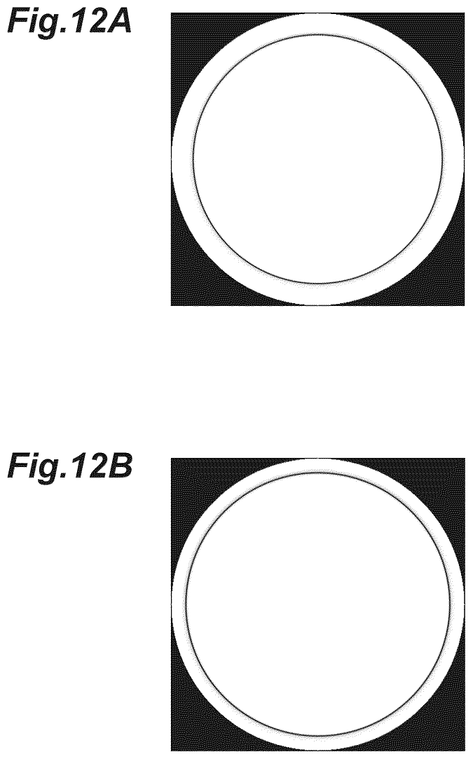

FIG. 12A is a diagram showing the reflected light intensity distribution on the pupil plane of the objective lens 27 in the case in which the thickness of the metal thin film 73 is set to 54 nm and the refractive index of the sample is set to 1.33. FIG. 12B is a diagram showing the reflected light intensity distribution on the pupil plane of the objective lens 27 in the case in which the thickness of the metal thin film 73 is set to 54 nm and the refractive index of the sample is set to 1.40.

As can be seen from FIG. 10, FIG. 11A, FIG. 11B, FIG. 12A, and FIG. 12B, the refractive index information of the sample can be obtained from the reflected light intensity on the pupil plane of the objective lens 27 (that is, the light intensity detected by the photodetector 40 in the configuration of the surface plasmon microscope 1A (FIG. 1)).

The refractive index of the sample can be represented by a function formula such as a polynomial formula in which the reflected light intensity is a variable, and linear approximation is also possible, and thus, the refractive index information of the sample can be obtained from the reflected light intensity by using the above function formula. Further, when the relationship between the refractive index of the sample and the reflected light intensity is obtained in advance and stored in a lookup table, the refractive index information of the sample can be obtained from the reflected light intensity by referring to the lookup table.

Further, the change of the reflected light intensity with respect to the refractive index change of the sample is larger (that is, the measurement sensitivity of the refractive index is higher) in the case of the thickness of 30 nm than in the case of the thickness of 54 nm. For example, when the refractive index of the sample is in the range of 1.3 to 1.4, the reflected light intensity change is about 2.8 times larger in the case of the thickness of 30 nm than in the case of the thickness of 54 nm. The above point is opposite to the technique of Non Patent Document 1.

As can be seen from FIG. 12A and FIG. 12B, in the reflected light intensity distribution on the pupil plane of the objective lens 27, the information on the surface plasmon resonance angle change due to the refractive index change included in the low NA region near the center (the low frequency region inside the absorption ring) is relatively small. Further, the low frequency region also includes the information which becomes noise, such as the transmittance change of the sample.

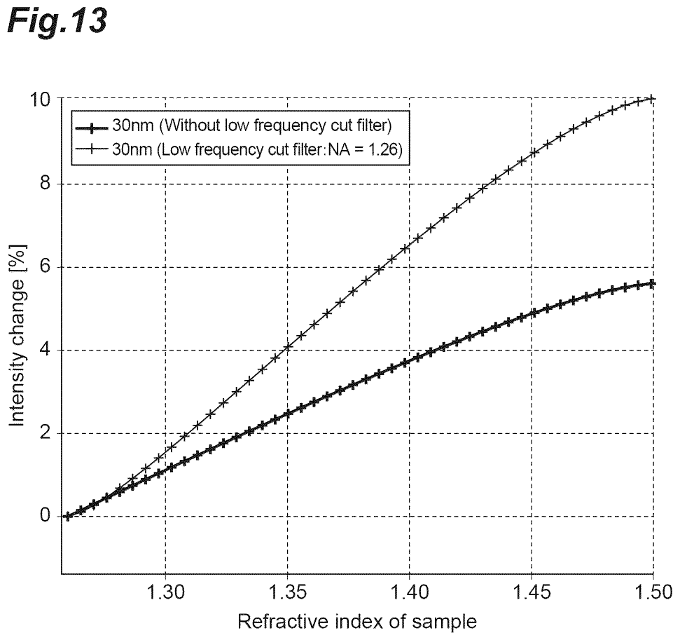

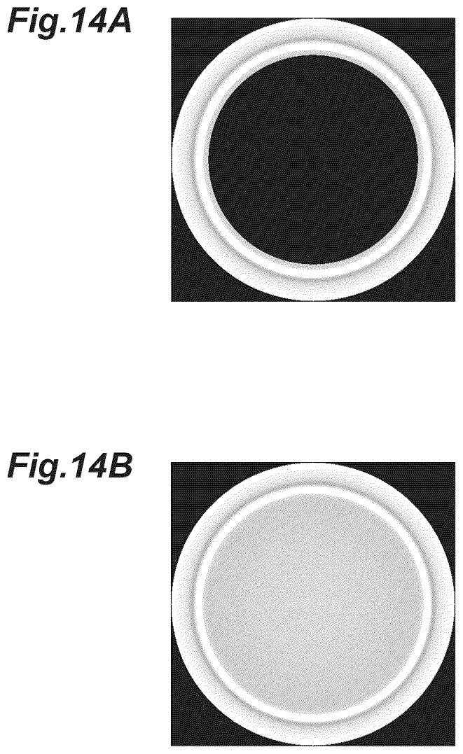

In consideration of the above, next, a simulation is performed on effects in the case in which the low frequency cut filter is provided as in the configuration of the surface plasmon microscope 1B (FIG. 3) or the configuration of the surface plasmon microscope 1C (FIG. 4) (FIG. 13, FIG. 14A, FIG. 14B).

FIG. 13 is a graph showing a relative change of the reflected light intensity on the pupil plane of the objective lens 27 in the case in which the metal thin film 73 is set to the silver thin film and the refractive index of the sample 74 is changed. In this graph of FIG. 13, the relative changes of the reflected light intensity respectively in the case in which the thickness of the metal thin film is set to 30 nm and the low frequency cut filter is not provided and the case in which the thickness of the metal thin film is set to 30 nm and the low frequency cut filter (NA=1.26) is provided are shown. The reflected light intensity in the case in which the refractive index of the sample 74 is set to 1.26 is used as the reference value.

FIG. 14A is a diagram showing the reflected light intensity distribution on the pupil plane of the objective lens 27 in the case in which the thickness of the metal thin film 73 is set to 30 nm and the low frequency cut filter (NA=1.26) is provided. FIG. 14B is a diagram showing the reflected light intensity distribution on the pupil plane of the objective lens 27 in the case in which the thickness of the metal thin film 73 is set to 30 nm and the low frequency cut filter is not provided.

As can be seen from FIG. 13, FIG. 14A, and FIG. 14B, in the case in which the low frequency cut filter is provided, the change of the reflected light intensity with respect to the change of the refractive index of the sample increases (that is, the sensitivity increases). In this case, the diameter of the low frequency cut filter is set such that the reflected light intensity is maximized when the refractive index of the sample is in the range of 1.3 to 1.4. The diameter of the low frequency cut filter can be set to an optimum value depending on the range of the refractive index to be measured.

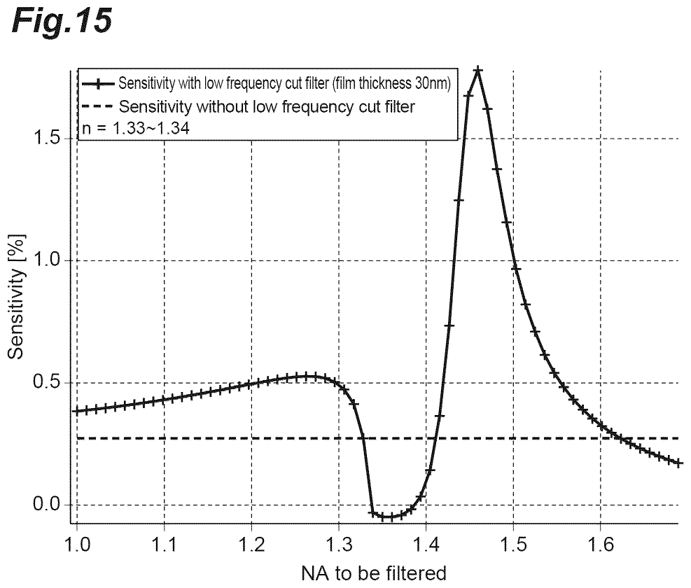

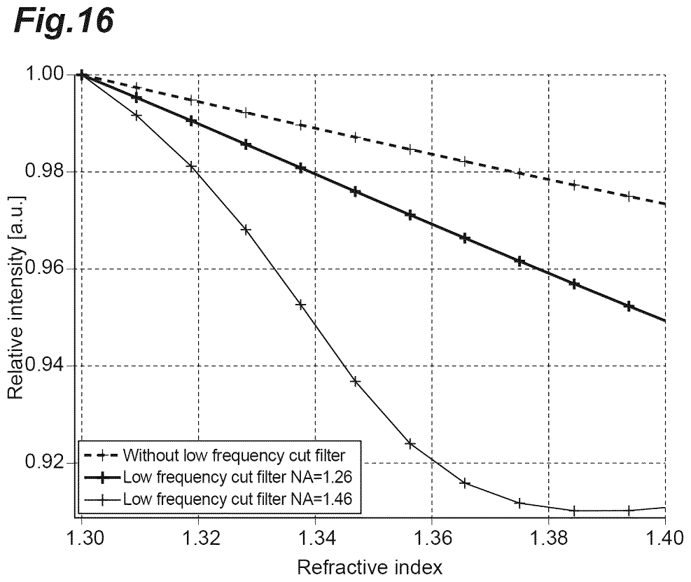

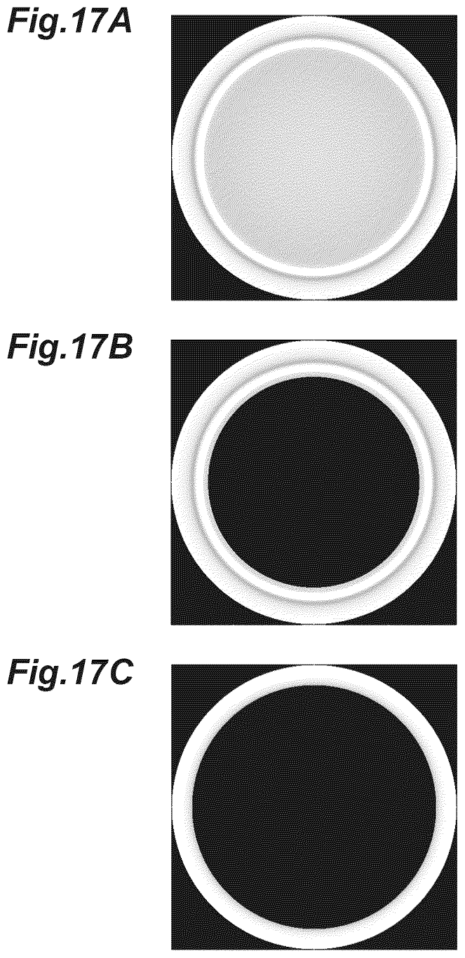

Next, simulations are performed by setting the diameter of the low frequency cut filter to various values (FIG. 15, FIG. 16, FIG. 17A to FIG. 17C).

FIG. 15 is a graph showing a change of the sensitivity in the case in which the metal thin film 73 is set to the silver thin film with the thickness of 30 nm and the diameter of the low frequency cut filter is changed. The horizontal axis indicates the diameter of the low frequency cut filter by NA. The vertical axis indicates the sensitivity when the refractive index of the sample is in the range of 1.33 to 1.34. Further, in this graph of FIG. 15, the sensitivity (about 0.3%) in the case in which the low frequency cut filter is not provided is indicated by a straight line of a dotted line.

FIG. 16 is a graph showing a relative change of the reflected light intensity on the pupil plane of the objective lens 27 in the case in which the metal thin film 73 is set to the silver thin film with the thickness of 30 nm and the refractive index of the sample 74 is changed. In this graph of FIG. 16, the relative changes of the reflected light intensity respectively in the case in which the low frequency cut filter is not provided, the case in which the low frequency cut filter of NA=1.26 is provided, and the case in which the low frequency cut filter of NA=1.46 is provided are shown.

FIG. 17A is a diagram showing the reflected light intensity distribution on the pupil plane of the objective lens 27 in the case in which the low frequency cut filter is not provided. FIG. 17B is a diagram showing the reflected light intensity distribution on the pupil plane of the objective lens 27 in the case in which the low frequency cut filter of NA=1.26 is provided. FIG. 17C is a diagram showing the reflected light intensity distribution on the pupil plane of the objective lens 27 in the case in which the low frequency cut filter of NA=1.46 is provided. The low frequency cut filter with NA=1.26 does not block the light in the region of the absorption ring, and further, the low frequency cut filter with NA=1.46 blocks a part of the light in the region of the absorption ring.

As can be seen from FIG. 15, FIG. 16, and FIG. 17A to FIG. 17C, in the case in which the low frequency cut filter of NA=1.26 is provided, the change of the reflected light intensity with respect to the change of the refractive index of the sample becomes large, and the sensitivity becomes about twice as high. Further, in the case in which the low frequency cut filter of NA=1.46 which blocks a part of the light in the region of the absorption ring is provided, the sensitivity is further increased, and on the other hand, the dynamic range is decreased.

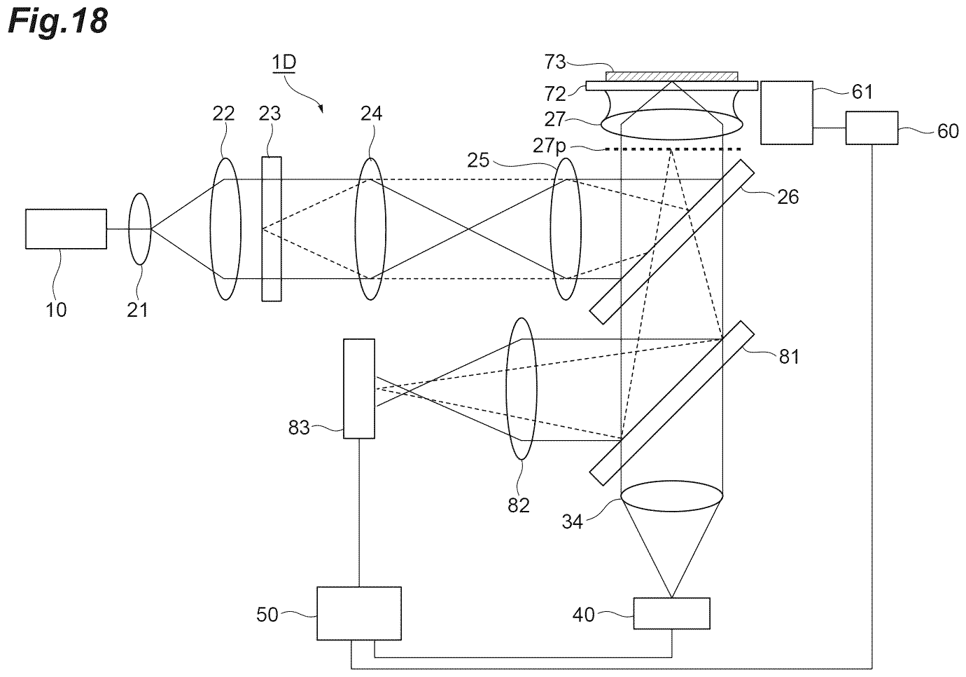

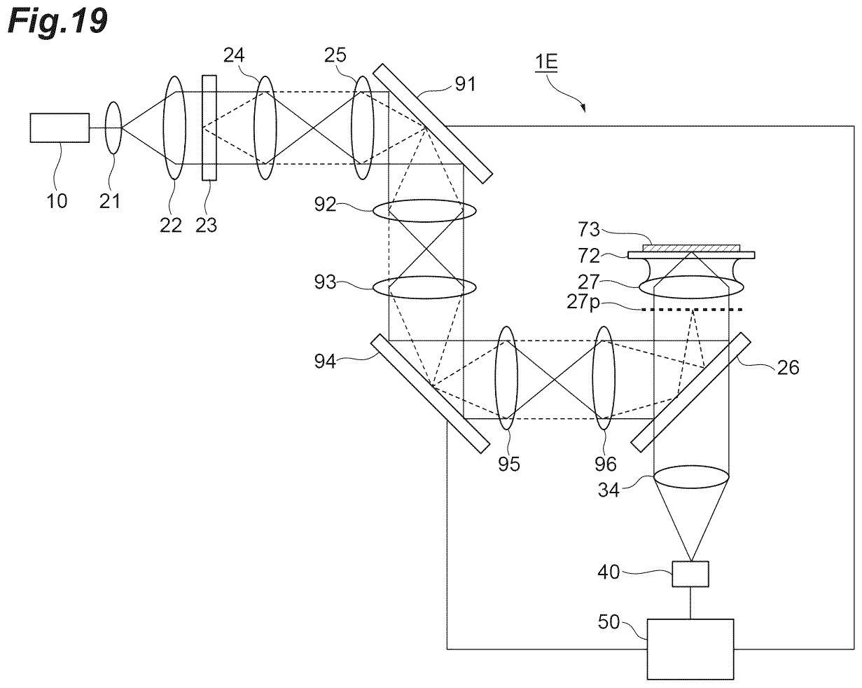

Next, other modifications of the configuration of the surface plasmon microscope 1A (FIG. 1) will be described (FIG. 18 and FIG. 19). In addition, the modifications described below can also be applied to the configuration of the surface plasmon microscope 1B (FIG. 3) and the configuration of the surface plasmon microscope 1C (FIG. 4).

FIG. 18 is a diagram illustrating a configuration of a surface plasmon microscope 1D. As compared with the configuration of the surface plasmon microscope 1A (FIG. 1), the surface plasmon microscope 1D (FIG. 18) is different in that the microscope further includes a beam splitter 81, a lens 82, and an imaging unit 83.

The beam splitter 81 and the lens 82 constitute a splitting optical system. The splitting optical system splits a part of the reflected light at a point on the optical path of the detection optical system (in the middle of the optical path between the beam splitter 26 and the lens 34), and guides the split reflected light to the imaging unit 83. The splitting optical system projects the pupil plane of the objective lens 27 onto an imaging plane of the imaging unit 83.

The imaging unit 83 receives the reflected light arriving through the splitting optical system, and images the intensity distribution of the reflected light on the pupil plane of the objective lens 27. The imaging unit 83 may be configured by using, for example, a CCD image sensor or a CMOS image sensor. The intensity distribution of the reflected light on the pupil plane of the objective lens 27 is acquired by the imaging unit 83, and the radius of the absorption ring in the reflected light intensity distribution is obtained by the operation unit 50, and thus, it is possible to obtain the refractive index information of the sample with high accuracy based on the radius of the absorption ring obtained as described above.

In the case of the above configuration, it is possible to selectively use simple acquisition of the refractive index information of the sample based on the light intensity detection result obtained by the photodetector 40, and highly accurate acquisition of the refractive index information of the sample based on the image of the reflected light intensity distribution obtained by the imaging unit 83.

FIG. 19 is a diagram illustrating a configuration of a surface plasmon microscope 1E. As compared with the configuration of the surface plasmon microscope 1A (FIG. 1), the surface plasmon microscope 1E (FIG. 19) is different in that the microscope includes a galvano mirror 91, a lens 92, a lens 93, a galvano mirror 94, a lens 95, and a lens 96, in place of the stage drive unit 60 and the stage 61, as the scanning unit for scanning the position of the focused illumination of the light on the metal thin film 73 by the illumination optical system. The above elements are inserted on the optical path of the illumination optical system (between the lens 25 and the beam splitter 26).

The light output from the lens 25 is reflected by the galvano mirror 91, passes through the lens 92 and the lens 93, and then is input to the galvano mirror 94. The light input to the galvano mirror 94 is reflected by the galvano mirror 94, passes through the lens 95 and the lens 96, and then is input to the beam splitter 26. The polarization element 23, the galvano mirror 91, the galvano mirror 94, and the pupil plane 27p of the objective lens 27 are in an optically conjugate positional relationship.

By changing an orientation of a reflection surface of each of the galvano mirror 91 and the galvano mirror 94, it is possible to scan the position of the focused illumination of the light on the metal thin film 73. As compared with the scanning of the focused illumination position by using the stage drive unit 60 and the stage 61, the scanning of the focused illumination position by using the galvano mirror 91 and the galvano mirror 94 is preferable in that it can be performed at a high speed.

As described above, in the surface plasmon microscope of the present embodiment, the light is focused on the metal thin film and the metal thin film is illuminated with the focused light by the illumination optical system, the reflected light generated by the focused illumination of the light is guided to the photodetector by the detection optical system, the reflected light intensity is detected by the photodetector, and the refractive index information of the sample is acquired based on the reflected light intensity. By using the above configuration, it is possible to simplify the configuration of the surface plasmon microscope of the present embodiment, it is possible to reduce the measurement time, and further, it is possible to simplify also the analysis at the time of acquisition of the refractive index information of the sample.

By using the surface plasmon microscope of the present embodiment, it is possible to easily measure the refractive index change and intermolecular interaction on a surface of a cell as the sample in real time. For example, by measuring the refractive index information of the cell surface, it is possible to acquire information on dynamics of proteins and lipids of a cell membrane, and it is possible to evaluate a response to a drug. It is possible to detect microparticles such as exosomes secreted from the cell. It is possible to measure the intermolecular interaction, and it is possible to perform bioassay. Further, it is possible to detect a bacterium or a virus in the sample.

Further, in the surface plasmon microscope of the present embodiment, by appropriately setting the thickness of the metal thin film, the diameter of the low frequency cut filter, and the like, it is possible to easily perform the measurement with higher sensitivity. Further, the thickness of the metal thin film and the diameter of the low frequency cut filter can be optimally set, for example, by using machine learning.

The surface plasmon microscope is not limited to the embodiments and configuration examples described above, and various modifications are possible.

The surface plasmon microscope of a first aspect according to the above embodiment is a surface plasmon microscope for acquiring refractive index information of a sample disposed in contact with a metal thin film by using a surface plasmon resonance phenomenon, and includes (1) a light source for outputting light; (2) an illumination optical system for focusing the light output from the light source on the metal thin film through an objective lens to generate a surface plasmon resonance; (3) a detection optical system for guiding reflected light generated by focused illumination on the metal thin film by the illumination optical system through the objective lens; (4) a photodetector for receiving the reflected light arriving through the detection optical system, and detecting an intensity of the reflected light; and (5) an operation unit for acquiring the refractive index information of the sample based on the intensity of the reflected light detected by the photodetector.

In the surface plasmon microscope of a second aspect, in the configuration of the first aspect, the microscope may further include a polarization element which is provided on an optical path of the illumination optical system, and for converting the light to be focused to illuminate the metal thin film into radial polarization.

In the surface plasmon microscope of a third aspect, in the configuration of the first or second aspect, the microscope may further include a low frequency cut filter which is provided on an optical path of the illumination optical system or the detection optical system, and for reducing a low frequency component inside an absorption ring out of the reflected light to be received by the photodetector.

In the surface plasmon microscope of a fourth aspect, in the configuration of the third aspect, the low frequency cut filter may be a filter including a spatial light modulator in which a spatial modulation distribution is set by an electrical signal provided from outside.

In the surface plasmon microscope of a fifth aspect, in the configuration of any one of the first to fourth aspects, the metal thin film may be formed on one surface of a transparent substrate, and the illumination optical system may guide the light output from the light source to converge the light by the objective lens, and may illuminate the metal thin film with the light from a side of another surface of the transparent substrate and may focus the light on the metal thin film.

In the surface plasmon microscope of a sixth aspect, in the configuration of any one of the first to fifth aspects, the microscope may further include a scanning unit for scanning a position of the focused illumination on the metal thin film by the illumination optical system.

In the surface plasmon microscope of a seventh aspect, in the configuration of any one of the first to sixth aspects, the microscope may further include a splitting optical system for splitting a part of the reflected light at a point on an optical path of the detection optical system, and guiding the reflected light after splitting; and an imaging unit for receiving the reflected light arriving through the splitting optical system, and imaging an intensity distribution of the reflected light on an exit pupil plane of the objective lens.

The embodiments can be used as a surface plasmon microscope capable of achieving simplification of a configuration and an analysis and reduction of a measurement time.

From the invention thus described, it will be obvious that the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A surface plasmon microscope for acquiring refractive index information of a sample disposed in contact with a metal thin film by using a surface plasmon resonance phenomenon, the surface plasmon microscope comprising:
a light source configured to output light;
an illumination optical system configured to focus the light output from the light source on the metal thin film through an objective lens to generate a surface plasmon resonance;
a detection optical system configured to guide reflected light generated by focused illumination on the metal thin film by the illumination optical system through the objective lens;
a photodetector configured to receive the reflected light arriving through the detection optical system, and detect an intensity of the reflected light; and
an operation unit configured to acquire the refractive index information of the sample based on the intensity of the reflected light detected by the photodetector.

2. The surface plasmon microscope according to claim 1, further comprising a polarization element provided on an optical path of the illumination optical system, and configured to convert the light to be focused to illuminate the metal thin film into radial polarization.

3. The surface plasmon microscope according to claim 1, further comprising a low frequency cut filter provided on an optical path of the illumination optical system or the detection optical system, and configured to reduce a low frequency component inside an absorption ring out of the reflected light to be received by the photodetector.

4. The surface plasmon microscope according to claim 3, wherein the low frequency cut filter is a filter including a spatial light modulator in which a spatial modulation distribution is set by an electrical signal provided from outside.

5. The surface plasmon microscope according to claim 1, wherein the metal thin film is formed on one surface of a transparent substrate, and the illumination optical system is configured to guide the light output from the light source to converge the light by the objective lens, and illuminate the metal thin film with the light from a side of another surface of the transparent substrate and focus the light on the metal thin film.

6. The surface plasmon microscope according to claim 1, further comprising a scanning unit configured to scan a position of the focused illumination on the metal thin film by the illumination optical system.

7. The surface plasmon microscope according to claim 1, further comprising:
a splitting optical system configured to split a part of the reflected light at a point on an optical path of the detection optical system, and guide the reflected light after splitting; and
an imaging unit configured to receive the reflected light arriving through the splitting optical system, and image an intensity distribution of the reflected light on an exit pupil plane of the objective lens.
